(19) United States
(12) Patent Application Publication
(10) Pub. No.: US 2007/0058574 A1
(43) Pub. Date: Mar. 15, 2007

(54) Organizational arrangements for self-coordinated machine networks

(76) Inventor: Roland F. Bryan, Santa Barbara, CA (US)

Correspondence Address: MARK RODGERS, 1590 SAN ROQUE ROAD, SANTA BARBARA, CA, 93105, US

(21) Appl. No.: 11/228,873

(22) Filed: Sep. 15, 2005

(51) Int. Cl. G08C 17/00; H04J 3/08; H04B 7/14; H04J 1/10

(52) U.S. Cl. 370/315; 370/311

(57) ABSTRACT

The invention is a mode of operation for an improved self-coordinated machine network. The invention is used for applications where individual machine may be dormant for a significant fraction of total use time to save power. The invention provides organizational functions which allow the network to save power by having machines cycle between dormant and active states while maintaining full functionality of the network.

### RELATED APPLICATIONS

This application is related to co-pending application Ser. No. 10/131,165, which is incorporated in it's entirety by reference.

### FEDERALLY SPONSORED RESEARCH

Not Applicable

### SEQUENCE LISTING

Not Applicable

### BACKGROUND OF THE INVENTION

This application relates to self-coordinated machine networks, and in particularly to applications where it is advantageous that the machines in such networks have low power consumption allowing for long life operating on battery power.

As described in co-pending application Ser. No. 10/131,165 by the same inventor and others, self-coordinated machine networks have many potential uses. These networks are characterized by each member of the network possessing sufficient intelligence and capacity to act independently as well as being able to keep track of the status and history of other members in the network community. Any member can initialize a new member and maintain the information of another member. This attribute permits member machines to move around spatially, and when they come into contact with a new community, to join in and share information with any community in communication range. Although many communication possibilities were discussed in the co-pending application, for purposes of the current invention, wireless communication between machines is the preferred approach.

An important application for these networks is security. Because the self-coordinated network member machines contemplated for security applications have intelligence, they can interface with sensors, process sensor information, store and share results, and communicate wirelessly. These attributes are ideal for security monitors.

One security use discussed in the co-pending application is shipping containers, considered a major vulnerable attack point for terrorists. A machine network of the type described in the co-pending application is sell-suited for this use. A container-dedicated machine can include sensors to know when the container is accessed or opened, motion detectors to know when it is moved, GPS capability to know where it is, and storage and acquisition of freight manifests to know what is contained and where it is bound. Thus a container with such a machine can travel around the marshalling yards and transport vehicles, and whenever it comes into contact with other container communities or shipping controllers on the network, can announce its presence, cargo and destination, whether or not it has been tampered with and where it has been. Obviously such a capability would greatly enhance shipping container security as well as provide commercial benefit to shippers.

Another security related use is intrusion detection. A number of machines can be dispersed in the area of a site to be protected. Each machine can include motion detection capacity and wireless communication, as well as knowledge of it's own location. Thus detected patterns of movement can be freely communicated among the machines, tracking and building a picture of movement patterns, and communicating to security control systems about patterns that are threatening.

A common element in many security applications, is that by their nature they entail field situations, where power may not be available, typically requiring network machines to operate on batteries. For instance, setting up an intrusion detection system around a military camp may require that machines be placed in the wild. Shipping containers typically both in transport and storage have no access to power. Moreover in both applications, the machines spend long periods of dormancy, where nothing is happening, also a common thread in security applications. Thus it would be advantageous for machines to last as long as possible on battery power for field security, taking advantage of the opportunity to conserve power where possible. The current invention provides improved organization schemes for machine networks that address these issues.

### BRIEF SUMMARY OF THE INVENTION

In one embodiment, the invention is an application for a self-coordinated machine network, which includes individual applications running independently on the member machines of at least one community of machines. These applications include a first function for producing a dormant state and an active state, a second function for detecting an event and a third function for communicating information related to a detected event. In a version, the communication path is wireless radio.

In one version, the first function cycles machines between a dormant and an active state with timing such that at least one machine always has an overlapping active state with at least one other machine. In another version, the application includes a function for ensuring two or more communities of machines are so timed that all machines in each community are cycled between the active and dormant state together.

In an aspect of the invention, the application includes a function for ensuring the machines are so timed that there is a period of overlap between the active periods of the communities. In another embodiment, the application includes a function for operating a machine containing event detection apparatus and processing and communication apparatus, such that the event detection apparatus is enabled during the dormant state, and when the detection apparatus detects an event, the processor and communications apparatus is caused to change from dormant to active and attempts to communicate the information related to the detected event.

In another version, the application running on at least one further machine includes a function to ensure that the machine is always active, thereby always available to receive a communication from an active state machine.

In an aspect, the always active machine communicates with the communities on one wireless frequency and each community communicates among it's members with a wireless frequency distinct from other communities and the frequency used by the always active machine. In one embodiment, the machines include intrusion detection devices, and the events to be detected include motion in the vicinity of the machine.

In another embodiment, the invention is a security system which includes at least one community of event detecting machines arranged in a self-coordinated network. Each machine communicates with other members of the community using wireless communication. In one version, the machines are dispersed to detect intrusion events in the neighborhood of a protected site. In another version the machines are dedicate to shipping containers. At least a portion of machines are cycled between an active and dormant state to reduce power consumption, and the cycling timing is chosen such that at least two machines' active periods always overlap, allowing for a machine to pass on it's status and history to the community before going dormant. Any machine detecting an event communicates information relating to the event. In another embodiment, the application includes a function for operating a machine containing event detection apparatus and processing and communication apparatus, such that the event detection apparatus is enabled during the dormant state, and when the detection apparatus detects an event, the processor and communications apparatus is caused to change from dormant to active and attempts to communicate the information related to the detected event.

In one version the security system further includes at least one second community of event detecting machines. At least a portion of members of each community are cycled between an active and a dormant state to reduce power consumption, and the timing of the cycling is such that the active periods of the communities overlap, allowing one community to provide status and history information to another before going dormant. In a further version related to intrusion detection, the two communities are interspersed with each other in an intrusion detecting pattern.

In another version the system includes at least one machine which is always active, wherein any machine detecting an event broadcasts the information to the always active machine.

In an aspect, communication with the always active machine is on one wireless frequency, and communication within a community is on a wireless frequency distinct from that used for communicating with the always active machine. In a version, when a community is in range of the always active machine, the community members are cycled between active and dormant such that the always active machine updates the community members during their active states. In another version, when a community is not in range of the always active machine, the community members are cycled between active and dormant such that there is always overlap between the active states of at least two machines allowing for the community to update itself. For the case of container dedicated machines, events include;

container doors opening,

unexpected move,

unexpected intrusion and

unexpected position change.

In another embodiment, the invention is a security system including at least two communities of event detecting machines arranged in a self-coordinated network such that each machine communicates with other members of the community using wireless communication. At least a portion of the machines are can be in either an active and dormant state, and a first community of machines is dispersed to detect intrusion events in the neighborhood of a protected site. The first community consists of machines configured with a motion detector and a processor, such that when the processor is dormant, the motion detector can cause the processor to become active upon detection of motion. The first community of motion detection machines is kept dormant to conserve power except in the instance of event detection. A second community is dispersed such that each member of the first community is within communication range of at least one active member of the second community, such that when a member of the first community goes active in response to motion detection, it can communicate the event and other identification information to at least one active member of the second community. In another version, the machine which detects an event attempts to communicate the event until another machine within communication range becomes active.

### BRIEF DESCRIPTION OF THE DRAWINGS

The invention will be better understood by referring to the following figures.

FIG. 1 shows an embodiment of the invention, particularly suitable for intrusion detection.

FIG. 2 shows one possible timing diagram for the invention

FIG. 3 shows another possible timing diagram

FIG. 4 illustrates an exemplary machine

FIG. 5 shows a timing diagram particularly suitable for intrusion detection

FIG. 6 shows another embodiment of the invention, particularly suitable for shipping container application

FIG. 7 shows a possible timing diagram for the embodiment of Fi

### DETAILED DESCRIPTION OF THE INVENTION

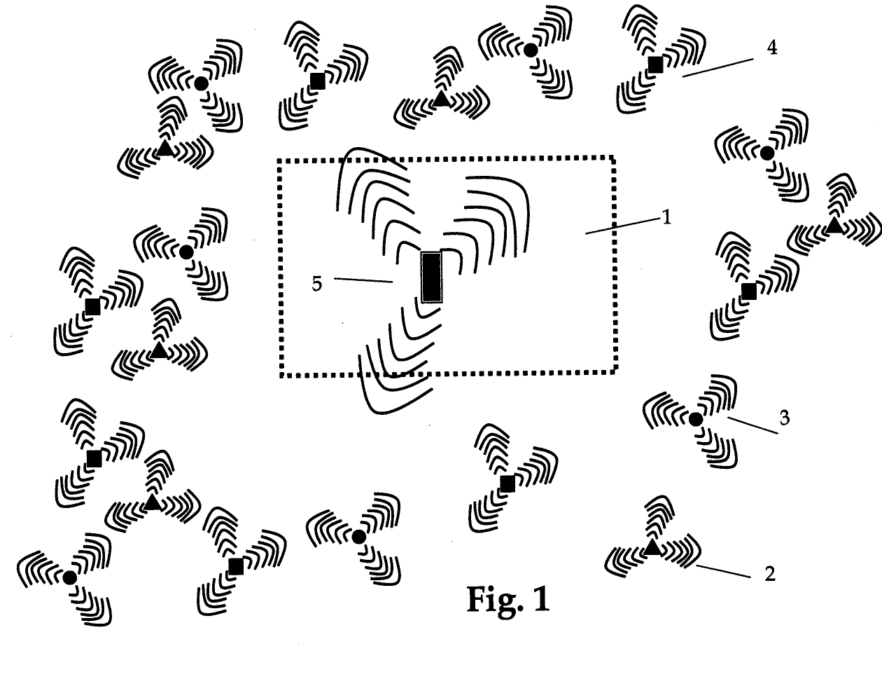

Referring to FIG. 1 an embodiment of the invention is shown which is applicable to an intrusion detection system. The example of the intrusion system is useful as an example of the invention. However other applications of the invention will be obvious to a skilled practitioner, so no limitation is implied by the intrusion system example. The scope of the invention is intended to include both security systems that practice the teachings of the invention, or applications that cause a system to practice the teachings of invention.

A site, such as a military encampment for example, is denoted schematically at 1. The invention in one embodiment can consist of one or more communities of machines, dispersed in such a way as to monitor possible intrusion paths to the site. The figure implies a situation such as a military encampment open to all sides, so the machines are shown dispersed to surround the site. However the teachings of the invention apply equally well to other situations such as permanent sites with limited access routes.

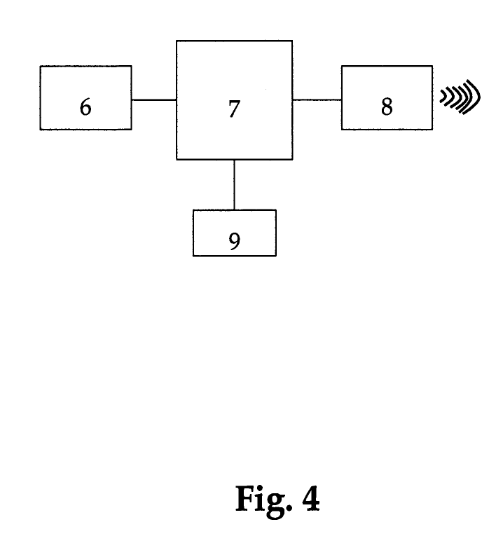

Three communities of machines are shown by way of example, although any number of communities, including only one community, is within the scope of the invention, The communities are denoted at 2, 3, and 4 schematically as different shapes, respectfully a triangle for community 2, a circle for community 3 and a square for community 4. In the figures, the reference numbers denote all of the members of a specific community, regardless of how many individual members are shown. As shown in FIG. 4, a typical machine would be a small, battery 9 powered device containing a motion detector 6, a processor and data storage unit 7 and a wireless communication link 8, preferably a radio link. Motion is intended to encompass motion, vibration or other parameters that can be detected to observe the passage of an object in the vicinity of the machine. These machines could be distributed around a site, in the wild, or for other applications be fixed to walls or other structures. These machines are preferably arranged in a self-coordinated network, such that each machine in a community knows and shares other community machine's locations, and event logs. Thus the machines can build up a pattern of detected events, and collectively determine if an actual intrusion is underway. If an intrusion is determined, the event can be communicated to a central controller 5.

Whether the machines are scattered in the bush around a camp, or placed on and around structures, it will usually be the case that they should be unobtrusive, and almost always should be the case that they use power efficiently, leading to a requirement that size and power consumption are typically parameters to be minimized. For instance, if the machines charge up using solar cells, it would be vital that they could last all night on the charge.

Size and power consumption can be partially addressed by machine design, but the requirements of the security application and nature of the self-coordinated network allow for the network to be organized in a fashion where power is used minimally, while maintaining effective functionality. Two attributes of the security application allow for a novel implementation of the self-coordinated network. First, for most machines, most of the time, nothing happens in their monitored space. Secondly, for many applications, the detectable area around a machine and the possible velocity of an intruder are such that by the standards of digital processing, an intruder is detectable for a relatively long period of time compared to the time necessary to acquire the detection.

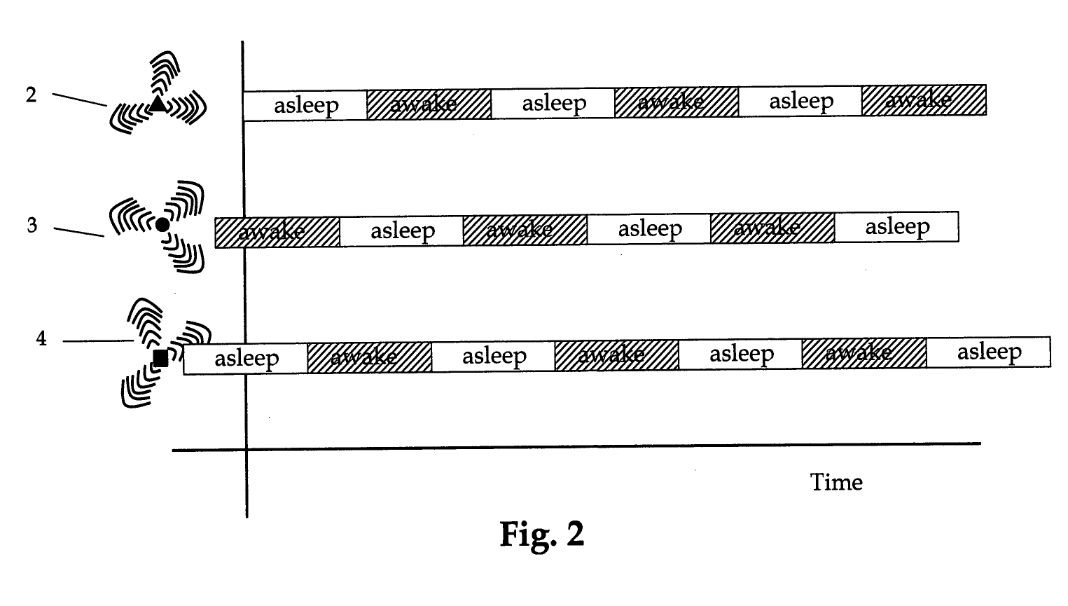

These attributes, either individually or in combination, effectively imply that most of the machines in the network can be dormant for a large percentage of total time. Referring to FIG. 2 for example, if the three exemplary communities, 2, 3 and 4 are interspersed, at any given instant, two of the three communities can be dormant. The communities can be cycled between an active and a dormant state such that only one community is active at a time. Preferably, as shown in the figure, the active and dormant states can be cycled in a fashion such that one community always goes active just before another goes dormant, such that the outgoing community updates the oncoming community of what has happened during the cycle. If the cycle times are picked within the intruder detection time window of each machine, then full coverage is achieved, and all machines are updated. If detected events build into a pattern that looks threatening, than a command can be generated for machines to stay awake until the situation is resolved.

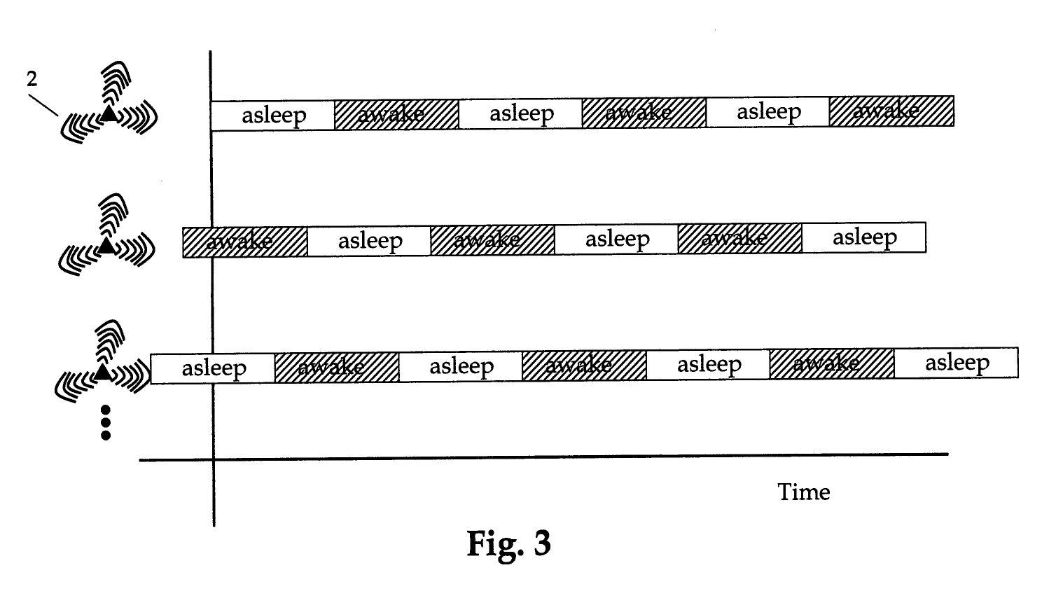

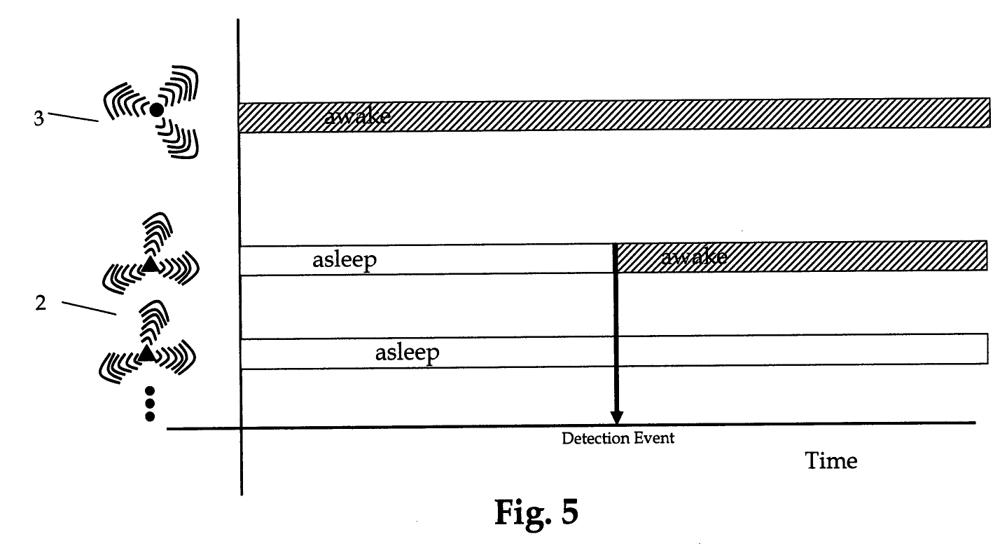

Referring to FIG. 3, cycling on and off can also take place within one community, schematically shown at 2. Again if the cycle times are overlapped, each machine going offline updates the machine coming online before going to sleep. The two modes can be combined as well. For instance an outer detection ring could be one community, cycling through it's members as shown in FIG. 3. Meanwhile, inner rings could be other communities that only come on intermittently until an event is detected in the outer ring. Another arrangement is shown in FIG. 5. In the arrangement of FIG. 5, the machine of FIG. 4 is so designed that the processor 7 and wireless link 8 are dormant during the “asleep” period, but the detector 6 still functions. Community 2 in FIG. 5 is asleep and remains asleep until an event is detected. Community 3 is awake, but community 3 can contain fewer members than community 2 as follows. Community 2 is dispersed in sufficient numbers to provide intrusion coverage, while community 3 is dispersed in numbers only sufficient to provide radio coverage for all members of community 2, basically to ensure that any member of 2 is within radio range of a member of 3. When a community 2 member's detector detects an event, that member's processor/link is woken and communicates to a member of 3. As the intruder passes more members of 2, each awakes and transmits to community 3. Thus the large number of detection machines is mostly asleep, while a smaller number of monitoring machines stays awake. Alternatively, all machines may be cycled between asleep and awake, such that when a machine detects an event and wakes up, it stays awake until another machine in range wakes up. The event detecting machine then delivers the event information. Many different arrangements will suggest themselves to a skilled practitioner. The nature of the self-coordinated network allows for machines to be dormant, and thus conserving power for most of the total time, with no loss of detection efficiency.

The example of FIG. 5 shows that it may be useful, to add one or more machines, which can be larger with a correspondingly large power source, and thus can be active for longer periods or even continuously, and possibly have longer range radio communication capability. These machines can act as gateways for smaller machines which are cycling or usually asleep, allowing for smaller transmitters in the cycling machines. The inventors have also found it useful if the gateway machines communicate on a different frequency than the communities use among themselves. Such an arrangement reduces traffic the gateways have to consider to just the essential information meant specifically for the gateway.

The gateway concept is useful for intrusion detection, but is particularly applicable to another application, shipping containers where machines can be dormant most of the time. Again, the case of shipping containers is used as a non-limiting example for clarity, but other applications will suggest themselves that are within the scope of the invention.

A container-dedicated machine, on a self-coordinated network, can perform a variety of functions including; acquire and maintain the container manifest, monitor and record access such as opened doors, track position via GPS, detect and indicate when the container is being moved, detect unexpected intrusions, and of course report and acquire similar information on the network about itself and other community members. However, for any given shipping event, the container is loaded, sits for a relatively long period of time, is moved and then sits again while transported, and is unloaded and stored for some period of time. Clearly the self-coordinated machines dedicated to containers can be dormant for large periods of time.

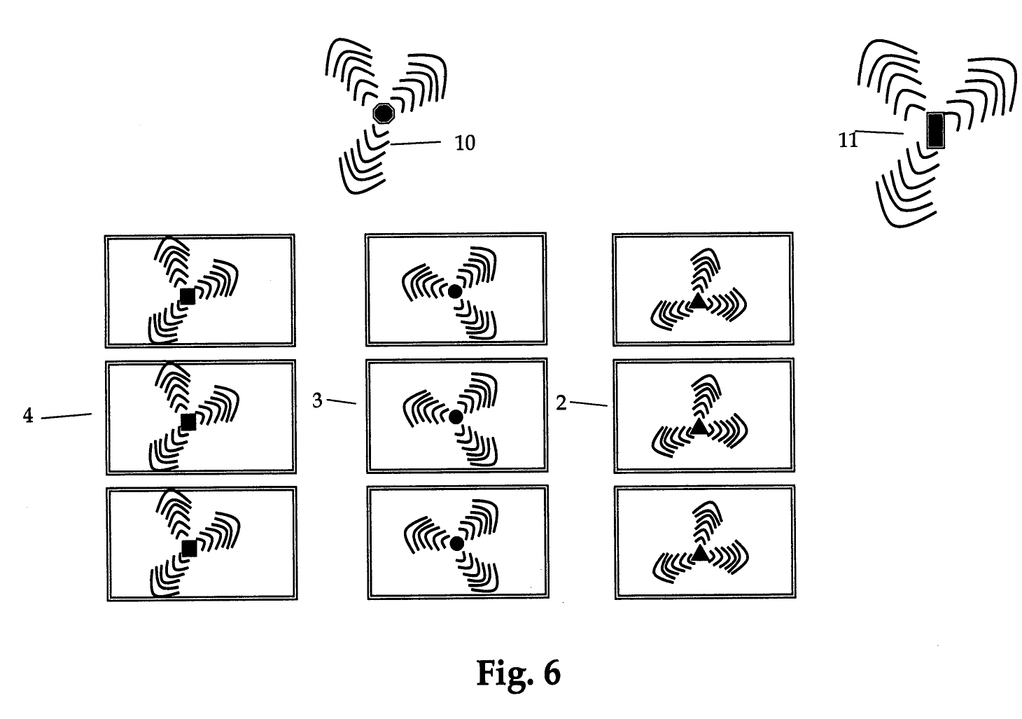

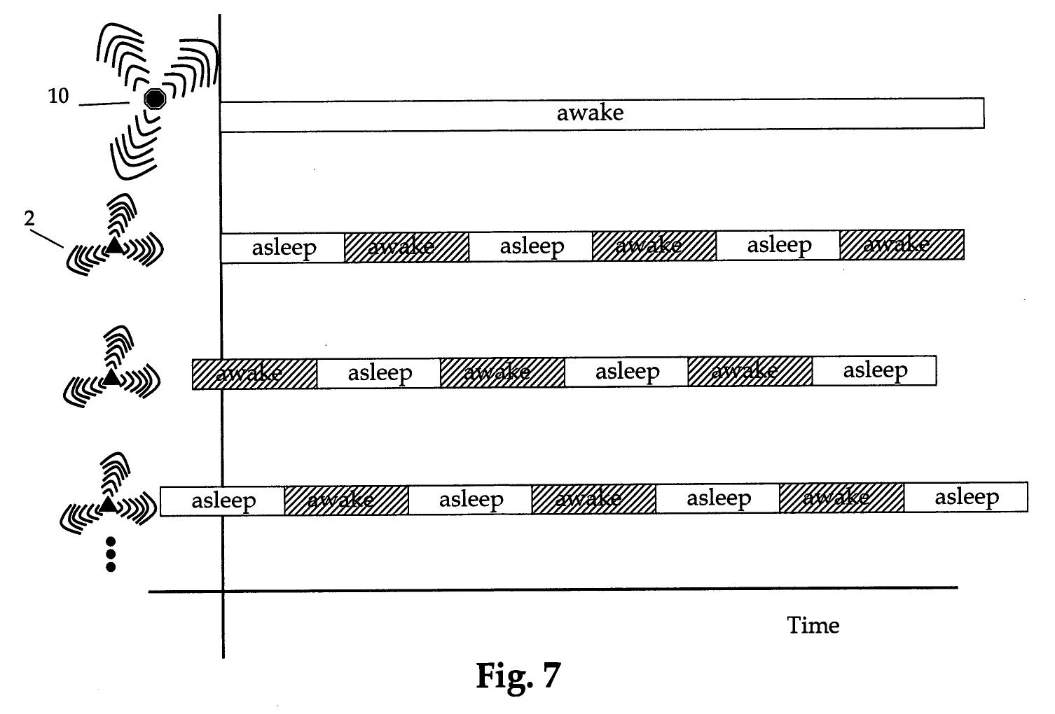

The gateway machine is particularly applicable to this application. Referring to FIG. 6, three communities are shown schematically at 2, 3 and 4. These machines must be power conserving since the containers may not have access to external power most of the time. However, within the transports, for example, trucks, ships, and trains, and in storage yards or warehouses, it typically is possible to have fixed or semi-fixed machine with access to power, shown at 10. These gateway machines may in turn communicate with a central controller shown at 11. Thus as shown in FIG. 7, machines within any community could cycle on and off, while the gateway machine is always on. Each machine when it comes on could check in with the gateway, report history and status and then go back to sleep. In this example the cycled machines could be asleep for fairly long cycle times, unless they were interrupted by a door being opened or a move.

The individual members would not necessarily have to overlap their active cycles if a gateway is present, since the gateway could handle the community updates. Thus when not in range of a gateway, the network could operate in an overlap mode, where communities update each other, and switch to a gateway supported mode allowing for longer sleep cycles when a gateway is present. So for example, a gateway machine may be in the yard, and another on the transport ship, but not in other locations during container transport. Thus, a container community could operate in self-support mode in between the yard and the ship, announce themselves and update the gateway when in the ship, and go into gateway supported mode until removed from the ship. When the communities arrive at the yard and come into contact with another gateway, again they would announce their presence, update the gateway machine and return to the gateway-supported mode of operation.

Thus it has been shown that a self-coordinated machine network can be operated in modes where machines are dormant for large periods of time to conserve power. The attributes of the self-coordinated network, which allow for organizational arrangements that preserve functionality for certain applications such as the examples described while conserving power, are, specifically:

1. machines within a community maintain and share each others data

2. any machine may initialize and update each other when machines cycle on and off.

1. An application for a self-coordinated machine network, comprising;
individual applications running independently on the member machines of least one community of machines, wherein the applications include;
a first function for producing a dormant state and an active state and,
a second function for event detection, and
a third function for communicating information related to a detected event.

2. The application of claim 1, wherein the first function cycles the machine between a dormant and an active state and generates timing such that at least one machine of the community has an overlapping active state with at least one other member.

3. The application of claim 1 wherein the application further includes a function for ensuring two or more communities of machines are so timed that all machines in each community are cycled between the active and dormant state together.

4. The application of claim 3 wherein the application includes a function for ensuring the machines are so timed that there is a period of overlap between the active periods of the communities.

5. The application of claim 1 wherein the first function includes;
operating a machine containing event detection apparatus and processing and communication apparatus, such that the event detection apparatus is enabled during the dormant state, and;
when the detection apparatus detects an event, the processor and communications apparatus is caused to change from dormant to active and attempts to communicate the information related to the detected event.

6. The application of claim 1 further comprising an application running on at least one machine which includes a function to ensure that the machine is always active, thereby always available to receive a communication from another active state machine.

7. The application of claim 6 wherein the always active machine communicates with the communities on one wireless frequency and each community communicates among it's members with a wireless frequency distinct from other communities and the frequency used by the always active machine.

8. The application of claim 1 wherein the machines include intrusion detection devices, and the events to be detected include motion in the vicinity of a machine.

9. The application of claim 1 wherein the communication is by means of wireless broadcasting.

10. A security system comprising;
at least one community of event detecting machines arranged in a self-coordinated network, wherein;
each machine communicates with other members of the community using wireless communication,
the machines are dispersed to detect intrusion events in the neighborhood of a protected site,
at least a portion of the machines are cycled between an active and dormant state to reduce power consumption,
the cycling timing is chosen such that at least two machines' active periods always overlap, allowing for a machine to pass on it's status and history to the community before going dormant; and,
any machine detecting an intrusion event communicates information relating to the event.

11. The system of claim 10 further comprising;
at least a second community of event detecting machines, wherein;
the two communities are interspersed with each other in an intrusion detecting pattern,
at least a portion of members of each community are cycled between an active and a dormant state to reduce power consumption; and,
the timing of the cycling is such that the active periods of the communities overlap, allowing one community to provide status and history information to another before going dormant.

12. The system of claim 10 further comprising at least one machine which is always active, wherein a community detecting an event communicates the information to the always active machine.

13. The system of claim 12 wherein communication with the always active machine is on one wireless frequency, and communication within a community is on a wireless frequency distinct from that used for communicating with the always active machine.

14. A security system comprising;
at least one community of machines arranged in a self-coordinated network, wherein;
each machine communicates with other machines using wireless communication,
at least a portion of the machines can be in either an active and dormant state,
a first community of machines is dispersed to detect intrusion events in the neighborhood of a protected site, the first community consists of machines configured with a motion detector and a processor, such that when the processor is dormant, the motion detector can cause the processor to become active upon detection of motion, and;
the first community of motion detection machines is kept dormant to conserve power except in the instance of an event detection.

15. The system of claim 14 wherein a second community is dispersed such that each member of the first community is within communication range of at least one active member of the second community, wherein when a member of the first community goes active in response to motion detection, it can communicate the event and other identification information to at least one active member of the second community.

16. The system of claim 14 wherein upon detection of an event, the machine attempts to communicate the event and continues to attempt to communicate the event until another machine within communication range is active.

17. A security system comprising;
at least one community of machines arranged in a self-coordinated network, wherein;
each machine communicates with other members of the community using wireless communication,
each machine is associated with a shipping container,
at least a portion of the machines may be in an active state, or in a dormant state to reduce power consumption, and;
any machine detecting an event communicates information relating to the event.

18. The system of claim 17 wherein the machines are cycled between an active and a dormant state, and cycle timing is chosen such that at least two machines' active periods always overlap, allowing for a machine to pass on it's status and history to the community before going dormant; and,

19. The system of claim 17 further comprising;
at least a second community of container-dedicated machines, wherein;
at least a portion of members of each community are cycled between an active and a dormant state to reduce power consumption; and,
the timing of the cycling is such that the active periods of the communities overlap, allowing one community to provide status and history information to another before going dormant.

20. The application of claim 17 wherein the application includes;
a function for operating a machine containing event detection apparatus and processing and communication apparatus, such that the event detection apparatus is enabled during the dormant state, and;
when the detection apparatus detects an event, the processor and communications apparatus is caused to change from dormant to active and attempts to communicate the information related to the detected event.

21. The system of claim 17 further comprising at least one machine which is always active, wherein a community detecting an event communicates the information to the always active machine.

22. The system of claim 21 wherein communication with the always active machine is on one wireless frequency, and communication within a community is on a wireless frequency distinct from that used for communicating with the always active machine.

23. The system of claim 21, wherein when a community is in range of the always active machine, the community members are cycled between active and dormant such that the always active machine updates the community members during their active states.

24. The system of claim 21, wherein when a community is not in range of the always active machine, the community members are cycled between active and dormant such that there is always overlap between the active states of at least two machines allowing for the community to update itself.

25. The system of claim 21 wherein events include;
container doors opening,
unexpected move,
unexpected intrusion and
unexpected position change.
